(19) United States
(12) Patent Application Publication
(10) Pub. No.: US 2002/0016170 A1
(43) Pub. Date: Feb. 7, 2002

(54) Using simulcast to improve wireless system functionality along corridors

(75) Inventors: John Sabat JR., Merrimack, NH (US); Peter Yelle, Chelmsford, MA (US)

Correspondence Address: David J. Thibodeau, Jr., HAMILTON, BROOK, SMITH & REYNOLDS, P.C., Two Militia Drive, Lexington, MA, 02421-4799, US

(73) Assignee: Transcept, Inc., Manchester, NH (US)

(21) Appl. No.: 09/820,282

(22) Filed: Mar. 28, 2001

Related U.S. Application Data
(60) Provisional application No. 60/192,748, filed on Mar. 28, 2000.

(51) Int. Cl. H04Q 7/20

(52) U.S. Cl. 455/436; 455/437; 455/456

(57) ABSTRACT

A method and apparatus for providing wireless signal communications through multiple coverage areas that include narrow corridors along which much of the mobile traffic travels. The corridors are interconnected at junctions where vehicle traffic tends to slow down or stop. The invention in particular, involves a method whereby simulcast communication is used for signal communication among base station locations along the narrow corridors. In this simulcast mode, the system equipment uses the same radio frequency to provide wireless coverage in a sequence of related sites located along the corridor. Using simulcast channels, the need for handoff is reduced and or eliminated. At the junctions, the usual base transceiver station (BTS) arrangement may be provided whereby multiple radio channels are available and handoff processing occurs.

### CROSS REFERENCE TO RELATED APPLICATION(S)

This application claims the benefit of a prior U.S. Provisional patent application, Ser. No. 60/192,748, filed Mar. 28, 2000, entitled “Method and Process of Using Simulcast to Improve Wireless Subway Functionality”, the entire teachings which are hereby incorporated.

### BACKGROUND OF THE INVENTION

In a cellular communication system, a pair of communication links is established between a mobile station, or subscriber, and a source base transceiver station (BTS). As a mobile station moves out of range of the source base transceiver station, the signal or the call “dropped”. To avoid loss of the communication links resulting from a dropped call, the communication links are shifted from the source base transceiver station to a target base transceiver station, or from a source sector to a target sector within the source base transceiver station coverage area. This process of making the shift is commonly referred to in the cellular communication area as a handoff process. A handoff may occur during a call in progress (e.g. from a traffic channel to a traffic channel), or during the initial signaling during call set-up.

Handoffs are generally classified into three types; a soft handoff, a softer handoff and a hard handoff. A soft handoff occurs when a mobile communication signal is transferred from a source base transceiver station (BTS) to a target BTS, the BTSs serving different cell coverage areas. The transfer occurs while the mobile station is in communication with both the source and target BTSs. Similarly, a softer handoff occurs when a mobile communication signal is transferred from a source sector to a target sector, both sectors associated with the same base transceiver station. The transfer occurs while the mobile station is in communication with both the source and target sector. During a soft and softer handoff, the mobile communication signal is supported simultaneously by both the source and target until the transfer to the target is complete. A hard handoff may occur when a mobile station is directed to re-tune to a new carrier frequency, and/or the control of resources supporting the mobile communication signal is transferred from a source base station controller to a target DSC.

As a result, base stations typically receive their absolute system time (a.k.a. timing synchronization) via a global positioning satellite (GPS), although other accurate central timing sources such as LORAN-C may be used. For a variety of reasons, some base stations do not have access to system timing synchronization. These reasons may include GPS outages as well as the physical location of the base station. For example, if no GPS is used in a CDMA system, it would be desirable to time synchronize all BTSs to one master BTS. In another example, a base station located in a subway tunnel, without benefit of timing synchronization provided by line-of-sight access to GPS, is highly unlikely to provide handoff capability for a mobile station communication signal. As a result, in order to provide handoff capability supplementary cabling etc. expenses associated with providing access to a GPS receiver are incurred.

Certain physical locations provide other challenges to the designers of wireless system infrastructure. Consider that highways, train tracks, and especially underground tunnels present narrow corridors along which vehicles travel. Thus, the typical base station radiating from a central location into a uniformly shaped cell does not provide optimum usage of either the available radio signal power or channel allocation. Current solutions for such enviromnents include the use of leaky radiating cables, remote antennas, localizing base stations, repeaters, and other Radio Frequency (RF) distribution solutions. However, even these solutions eventually encounter winding narrow paths that reduce the ability to illuminate an area with a wireless signal. Along a lengthy tunnel, the need to illuminate areas and to support handover between cells as mobile units travel at high speed through such areas thus requires additional design considerations.

Further complicating the situation with illuminating of a tunnel, densely packed trains carrying many potential callers create huge pockets of capacity laden vehicles speeding through many different cells in a very short period of time. This creates additional challenges in efficiency and quickly resolving handoff requests.

In the typical wireless communication system base station transceivers having tower mounted antennas are typically located on hill tops or atop tall buildings to provide communications between wireless telephones operating in a physical area, called a cell, and the telephone system. Physical characteristics of the geographical area covered by such a prior art transceiver may include other hills, tall buildings and other obstructions which create areas, or “blind spots”, in which communications between a wireless telephone and the remote transceiver that is assigned to handle the wireless telephony traffic for the area or cell is poor or non-existent.

Physical characteristics and initial network design also lead to other interference situations that also lead to poor call quality or interruption of wireless telephone service.

Prior art approaches to solving these problem have been to make the antenna tower higher and to increase the transmitted power, but even these solutions sometimes have not been able to eliminate all such blind spots and there is loss of signal transmission in these areas.

### SUMMARY OF THE INVENTION

The present invention is a method and apparatus for providing wireless signal communications through multiple coverage areas that include defined areas such as narrow corridors along which much of the mobile traffic travels. The invention, in particular, involves a method whereby simulcast communication is used for signal communication along the defined areas such as narrow corridors. In this simulcast mode, the system equipment uses the same radio frequency to provide wireless coverage in a sequence of related or adjacent cells located along the corridor. Using simulcast channels, the need for handoff is reduced and or eliminated.

The corridors may be interconnected at junctions where traffic tends to slow down or stop. At the junctions, the usual base transceiver station (BTS) arrangement may be provided whereby additional radio channels are available and handoff processing occurs.

The invention eliminates handovers between illumination areas along the corridor. Since they are operating in simulcast, no handover needs to take place as a mobile unit travels from cell to cell. As a result, the many active calls placed by train passengers hurdling at high speed through many relatively small coverage areas are better serviced.

Consider also that when the railway car reaches a high traffic junction between corridors, such as at a subway station, the vehicles naturally tend to slow down and/or stop. In such an area, wireless coverage as provided by a conventional multi-channel base station is then employed. The demand for handovers is greatly reduced in such locations since the units themselves are stationary and are moving only at low speed within the cell.

Segregating the type of radio coverage employed depending upon the area being a narrow corridor or a junction between the narrow corridors, also permits specific allocation of radio channels to be controlled according to railway timetables. For example, unlike the typical adaptive channel allocation which is responsive to traffic demand of known traffic timetables can be used to allocate radio channel resources in advance by the system operator. One or more channels are allocated to one of the narrow corridors when it is known or expected that a train will be traveling through the corridor, The channel allocation can then be removed from the corridor and made available elsewhere during periods of time when it is known that traffic will not be

In yet another scenario, a schedule may be used to determine that particular vehicle is an express or not otherwise planned to stop at the junction. In such a case, the channels in simulcast can remain in simulcast as the vehicle travels through the station at speed. This also avoids a situation where calls would otherwise be dropped as the vehicle travels at high speed.

Thus, by managing underground wireless access based upon a location of trains and/or timetables, the use of simulcast in problematic coverage areas is further enhanced.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a typical wireless telephony system utilizing remote transceivers (BTSs) and antenna towers integrated with Remote Antenna Drivers (RADs) and a Broadband Distribution Network;

FIG. 2 is a more detailed block diagram of the circuitry implementing the teaching of the present invention integrated with a wireless telephony system utilizing remote transceivers (BTSs) and antenna towers;

FIG. 3 is a general block diagram of a typical Base Transceiver Station (BTS) used in a wireless telephony system to carry telephony signals between a telephone system and a tower mounted antenna;

FIG. 4 is a detailed block diagram of the portion of a Remote Antenna Signal Processor (RASP) which is connected to a Base Transceiver Station (BTS) and transmits telephony signals originating at the telephone system, via a broadband distribution network to a Remote Antenna Driver (RAD) which is located in an area in which radio tower mounted antenna signal coverage is poor, non-existent, or interfered with;

FIG. 5 is a detailed block diagram of the portion of a Remote Antenna Signal Processor (RASP) which is connected to a Base Transceiver Station (BTS) and receives telephony signals originating at wireless telephones and carried via the broadband distribution network from a Remote Antenna Driver (RAD);

FIG. 6 is a detailed block diagram of the portion of a Remote Antenna Driver (RAD) that transmits telephony signals received via a Broadband Distribution Network from a Base Transceiver Station (BTS) and a RASP to wireless telephones; and

FIG. 7 is a detailed block diagram of the portion of a Remote Antenna Driver (RAD) that receives telephony signals from wireless telephones, and forwards the signals via the broadband distribution network to the RASP and BTS.

### DETAILED DESCRIPTION OF A PREFERRED EMBODIMENT

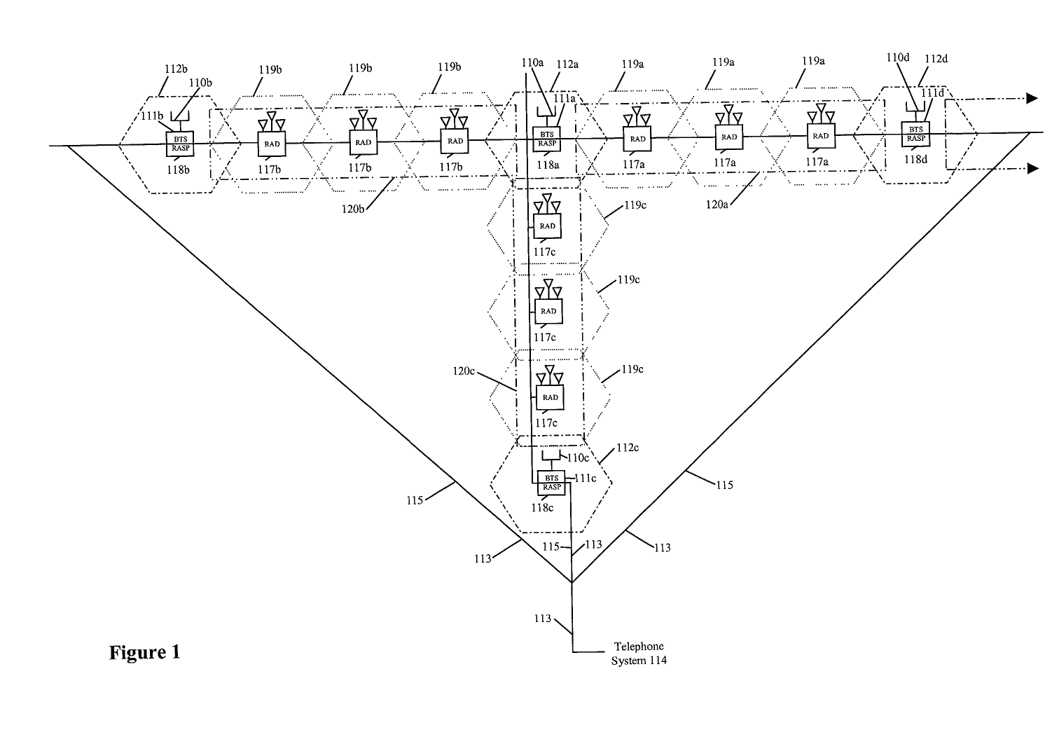

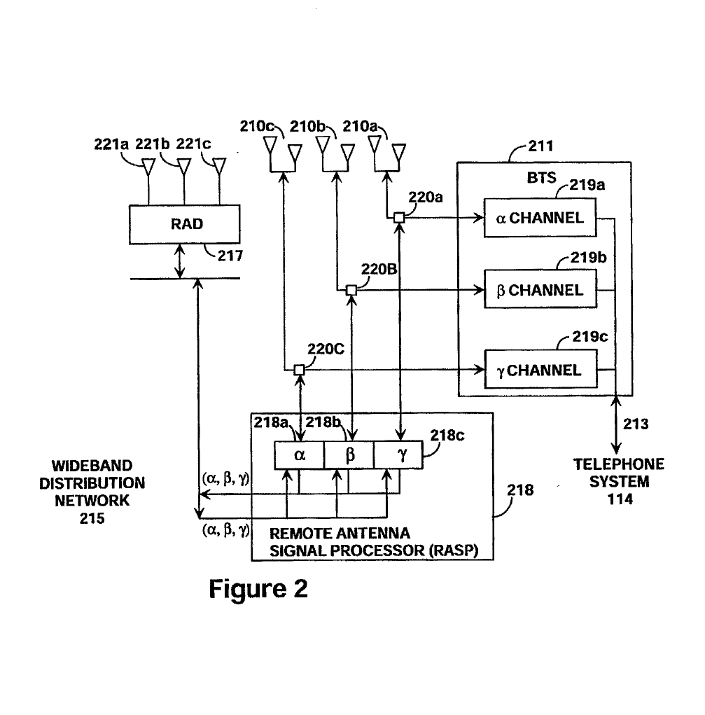

In the drawings and following detailed description all circuit elements are assigned three digit reference numbers. The first digit of each reference number indicates in which Figure of the drawing an element is shown. The second and third digits of each reference number indicate specific circuit elements. If the same circuit element appears in more than one Figure of the drawing, the second and third digits of the reference number for that circuit element remain the same and only the first digit of the reference number changes to indicate the Figure of the drawing in which the circuit element is located. Thus, Remote Antenna Driver (RAD) 217 in FIG. 2 is the same RAD labeled 117 in FIG. 1.

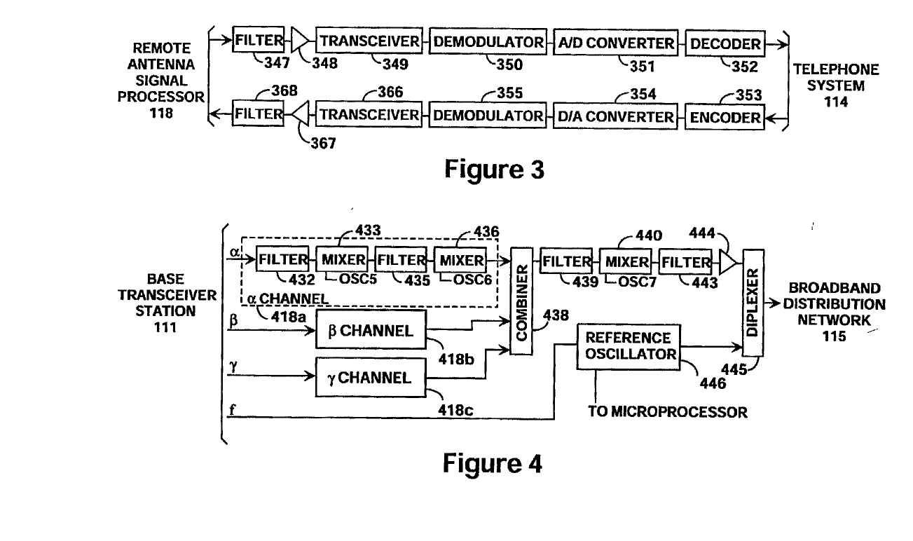

The term “reverse direction” refers to any signals traveling from a RAD 117 toward Telephone System 114, and the term “forward direction” refers to any signals traveling from Telephone System 114 toward a RAD 117. In the cable television industry the “forward direction” is referred to as “downstream”, and the “reverse direction” is referred to as “upstream”. This is mentioned because the present invention may be implemented into a wireless telephone system as described herein utilizing a cable television distribution cable. Other distribution networks such as fiber optic, wireless, and other types of networks that may exist in the future; and such networks may be dedicated or shared. As used herein the term “telephony signals” includes voice, data, facsimile and any other type of signals that are sent over a telephone network now or the future. Throughout this Detailed Description, when FIGS. 3 through 7 are being described, reference is often made to an element such as RAD 117, RASP 118 and BTS 111 in FIG. 1 to remind the reader what circuits these Figures are part of, although the reference numbers 111, 117 and 118 do not actually appear in the Figure being described.

Wireless telephony systems commonly utilize a plurality of remote transceivers (Base Transceiver Stations) 111 with associated antennas to handle wireless telephone traffic in a number of contiguous areas called cells. Despite multiple transceivers (BTSs) being located to provide area coverage, and even overlapping areas of signal coverage, there may still be “blind” areas of signal coverage. Such blind areas may be located in areas where radio signal propagation is poor, such as along narrow corridors like subway tunnels. Other such areas of continuous cells may be created above ground along railway tracks or highways where vehicles traveling at high speed carry many passengers engaged in wireless calls.

With the present invention a series of transceivers called Remote Antenna Driver (RADs) 117 are physically placed along each contiguous area or corridor 120 to provide signal coverage therein. As will be understood shortly, the RADs are a sort of signal repeater that is connected via a broadband distribution network, such as cable television cable or dedicated fiber strand/bundle, to a Remote Antenna Signal Processor (RASP) 118 which is co-located with a Base Transceiver Station (BTS) 111 with tower mounted antenna.

An encoded telephony signal being transmitted by a BTS 111 using its platform antenna is thus also carried via a dedicated cable or a broadband distribution cable or dedicated fiber strand/bundle in the corridor or tunnel to the associated RADs 117 to be simultaneously broadcast (“simulcast”) in the corridor or tunnel. Signals being received by the RAD 117 from a wireless telephone are carried by the dedicated cable or broadband distribution cable or fiber and combined with the signal being received by the hilltop antenna. In this way, using RADs 117 within the coverage area of a platform antenna may be shaped, and also used to cover blind spots within the corridor or tunnel. This is different than a repeater to and from which signals that are to be repeated are transmitted to and from the BTS 111 over the airwaves, not by a dedicated cable/fiber, and be received in areas where the transmitted signal may cause other spectrally related reception problems.

Each simulcast may actually encompass a series of such RADs 117 and associated coverage areas 119. Thus, it should be understood that all of the RADs 117a associated with areas 119a located along corridor 120a are using the same radio channels, or are said to be in simulcast. Thus, as a mobile subscriber unit moves along the corridor 120a, the same radio channel, say at radio frequency carrier F1 is used for communication, even though it travels through multiple cells 119a. This has the effect of preventing the BTS 111a and/or mobile units from engaging in handoff processing while the mobile unit is traveling along the corridor—indeed as far as the BTS 111a is concerned, the mobile unit is in the same cell as it travels, even though it really is not. As for the BTS 111 radio environment can tell, the subscriber unit has remained in the same cell and no handoff is therefore required. It is only upon reaching the cell 112a at the station, where a second carrier frequency, F2, is in use, that a handoff will occur.

It should be understood that a single radio carrier, F1, is sufficient for supporting a call using some wireless protocols, such as Advance Mobile Phone Service (AMPS) or Code Division Multiple Access (CDMA). However, other protocols such as Time Division Multiple Access (TDMA) use frequency hopping whereby a group of carriers are needed to support a single call. Thus, it should be understood that the reference here to “F1” and “F2” may also include a group of carriers in simulcast.

In cases where the corridor 120 is a subway tunnel or train track, the allocation of radio frequencies may be made according to an expected schedule of vehicle travel. One or more channels, F1, can thus be allocated for simulcast by RADs 117a during a short period of time that it is expected or known that a subway or railcar is traveling down corridor 120a. The channel F1 can then be taken away from RADs 117a when the corridor 120a is known to be empty, and allocated elsewhere.

In another case the subway or railcar may not be scheduled to stop at the junction. In this case, it will be desirable for the simulcast to continue, such that the same radio channels F1 remain in use as the mobile unit moves from cells 119a along the corridor 120a and even while it moves into cell 112a at the station and then continues down corridor 119b and cells 120b.

Now more particularly, FIG. 1 shows a diagram of a wireless telephony system according to the invention. The system utilizes a number of antenna towers 110a-d, located in or near the junction, to provide wireless telephone signal coverage in assigned cells 112a-d. The system is deployed to provide wireless signal coverage through multiple coverage areas, or cells 112 and 119. Most of the coverage areas 119 are located along corridors 120 such as a subway tunnel, railroad track or highway. Other coverage areas, or cells 112 are located at platforms, stations, or junctions between the corridors. Each antenna tower 110a-d has a Base Transceiver Station (BTS) 111a-d associated therewith as is known in the art. Each BTS 111a-d encodes analog or digital telephony signals received from a telephone system 114 for transmission to wireless telephones. The type of coding that is done depends upon the type of system and includes, but is not limited to, the well-known 15-95 Code Division Multiple Access (CDMA) and Global System Mobile (GSM) systems.

BTSs 111a-d are connected via a telephone distribution network 113 to a telephone system 114 in a manner well known in the art. Telephone distribution network 113 is often a T1 carrier. Telephone distribution network 113 is comprised of wire, coaxial cable, fiber-optic cable, and radio links as is also known in the art. Wire, coaxial cable, and fiber-optic cable are often hung on telephone poles (not shown), but are also buried. Often hung on the same telephone poles is a cable television distribution network 115 which usually comprise coaxial and fiber-optic cable as previously mentioned. For this reason, in FIG. 1 only single, dark lines are shown, designated both 113 and 115 to represent both telephone distribution network 113 and cable television distribution network 115. In FIG. 1 there are three branches, all designated 113 and 115. In the following description, the cable television distribution network is referred to as a broadband distribution network since any broadband network may be utilized.

In a manner well known in the prior art, as the user of a wireless telephone (not shown) moves from one cell to another cell, it is “handed off” to a new cell to maintain wireless telephone signal coverage.

As may be seen in FIG. 1 there are multiple access 119 between the conventional cells 112 that represent a physical area in which wireless telephone service is to be efficiently provided to support rapidly moving vehicles along a narrow corridor 120. Indeed, in the case of a subway tunnel, radio coverage may not be adequately provided at all.

To provide this improved wireless telephone service in a such areas 119, wireless communications signals carried between a wireless telephone (not shown) in an area 119a and a BTS 111a are carried over an alternate path, which includes a Remote Antenna Signal Processor (RASP) 118a, broadband distribution network 115, and Remote Antenna Drivers (RADs) 117a. Thus, for example, at the same time that an encoded telephony signal, which originated at Telephone System 114, and destined for a wireless telephone (not shown) located in area 119a, is being transmitted by BTS 111a and antenna 110a; the same encoded telephony signal is also sent via RASP 118a in a frequency division multiplexing format over broadband distribution network 115 to RADs 117a which simultaneously transmit (“simulcasts”) at low power the same telephony signal in areas 119a. It should again be noted that other broadband distribution networks, other than cable television distribution network 115, may be utilized to connect each RASP 118 and RAD 117. Alternatively, a dedicated cable may be provided to interconnect each RASP 118 and RAD 117.

Telephony signals originating from a wireless telephone (not shown) located in area 119a are received by RAD 117a which adds control signals and sends them in frequency division multiplexed signaling via broadband distribution network 115 and RASP 118a to BTS 111a. If the wireless telephone is in the portion of area 119c closer to cell 112c, its telephony signals are carried by RAD 117c and RASP 118c. More detailed descriptions of the operation of RADs 117 and RASPs 118 are given further in this Detailed Description.

In each of BTSs 111a-d are a plurality of transceiver modules (not shown), as is known in the wireless telephony art, each of which operates at a single channel frequency at a time, and which can handle a predetermined maximum number of telephone calls from wireless telephones. In the wireless telephony art, these transceiver modules in the base transceiver stations 111 are also referred to as channel card modules and radio modules.

In a preferred embodiment, each RAD 117 has three antennas, as shown, used to transmit signals to and receive signals from remote wireless telephones (not shown) operating in its associated area 119. One antenna is used to transmit encoded, wireless telephony signals to wireless telephones, while the other two antennas are used to receive wireless encoded, telephony signals from wireless telephones. One receive antenna is called the primary antenna, and the other receive antenna is called the diversity antenna. The two receive antennas are physically spaced and cooperate to minimize signal fading and thereby provide continuous signal reception from wireless telephones.

In FIG. 2 is shown a block diagram of a prior art BTS 211 with tower mounted antennas 210, and the implementation of the present invention showing how a RASP 218, Broadband Distribution Network 215, and RAD 217 are integrated with a BTS 211. As previously mentioned, BTS 211 is connected via a telephone distribution network 213 to a telephone system 114.

Each prior art BTS 211 has three channel circuits designated alpha 219a, beta 219b, and gamma 219c. Each of these three channel circuits 219a-c receives analog or digital telephony signals from telephone system 114, and encodes them. The type of encoding that is done depends upon the type of wireless telephone system and includes, but is not limited to, the well-known CDMA and GSM systems. The encoded signals are transmitted via a transmit antenna 210 to be received by a wireless telephone (not shown) operating in the cell in which BTS 111 is located. In FIG. 2 three sets of antennas 210 are shown. Antenna 210a is used by channel circuit 219a, antenna 210b is used by channel circuit 219b, and antenna 210c is used by channel circuit 219c.

In addition, each of the three prior art channel circuits 219a-c receives encoded telephony signals via its associated antenna 210a-c from wireless telephones (not shown) operating in the cell in which BTS 211 is located. The particular one of channel circuits 219a-c that receives the signals decodes the telephony signal to analog or digital format and sends it via telephone distribution network 213 to telephone system 114.

In accordance with the teaching of the present invention, a directional coupler 220a-c is connected between each of the channel circuits 219a-c and its associated one of antennas 210a-c. These couplers 220a-c are used to tap off telephony signals being transmitted via antennas 210a-c and, using RASP 218 and Broadband Distribution Network 215, sends the encoded telephony signals to RAD 217 for simultaneous (“simulcast”) transmission in blind area 116. These directional couplers 220a-c are also used to take telephony signals received by RAD 217 from wireless telephones (not shown) operating in blind area 116 and combine them with signals being received by antennas 210a-c for input to BTS 211 channel circuits 219a-c. The coupler can include electronic interfaces as well.

There is a RASP 218 assigned to each BTS 211, and each RASP 218 has three channel circuits designated alpha channel 218a, beta channel 218b, and gamma channel 218c that correspond to the alpha, beta and gamma channels 219a-c in BTS 211, as shown in FIG. 2. The circuitry in channel circuits 218a-c of RASP 218 translates the frequency of encoded telephony signals passing between RAD 217 and BTS 211, as necessary for transmission over the Broadband Distribution Network 215. In addition, the circuitry in channel circuits 218a-c of RASP 218 adds control signals to encoded telephony signals going to RAD 217, and separates control signals generated by RAD 217 from encoded telephony signals received from RAD 217. This operation is described in greater detail further in this Detailed Description.

RAD 217 has three antennas 221a-221c. Antenna 221a is used to transmit telephony signals that originated at telephone system 114 and being sent to a wireless telephone (not shown) in blind area 116. Antennas 221b and 221c are both receive antennas, with antenna 221b being called the primary receive antenna, and antenna 221c being called the secondary receive antenna. Antennas 221b&c both receive telephony signals originating from a wireless telephone (not shown) in blind area 116 and forwards both signals in frequency multiplexed format to RASP 218. Antennas 221b&c are physically spaced and cooperate to minimize signal fading and thereby provide continuous signal reception from wireless telephones operating in blind area 116. The operation of RAD 217 is described in greater detail further in this Detailed Description

Turning now to FIG. 3, therein is shown a general block diagram of a typical prior art Base Transceiver Station (BTS) 311 used in a prior art wireless telephony system. As mentioned above in the description of FIG. 2, there are three channel circuits in each BTS. As all three channel circuits are identical, only the alpha channel circuitry 319a is shown in FIG. 3 for the sake of simplicity. In FIG. 3 are two rows of circuits. The upper row of FIG. 3 shows the reverse direction circuitry of alpha channel 319a that carries telephony signals from a wireless telephone (not shown) to telephone system 114. The lower row of FIG. 3 shows the forward direction circuitry of alpha channel 319a that carries telephony signals originating at telephone system 114 and carries them toward a wireless telephone (not shown).

In the reverse direction of alpha channel 319a of BTS 311, an RF carrier signal, modulated with an encoded wireless telephony signal that is received by antenna 210a, or is received via a RAD 117 in blind area 116 via the alpha channel 218a of the associated RASP 218, is input via bidirectional coupler 220a to filter 347 which removes spurious signals at the input of BTS 311. The received RF carrier signal is then amplified by amplifier 348 and input to transceiver 349. Transceiver 349 is used to translate the frequency of the RF carrier signal, received from either RASP circuit 218a or antenna 210a, via bidirectional coupler 220a, to an IF carrier signal which is input to demodulator 350. Demodulator 350 extracts the encoded telephony signal from the IF carrier signal in a manner well-known in the art. In different prior art BTSs 311 the decoded signal may either be an analog or digital signal, depending on the type of system. In the wireless telephony system described herein, the well known GSM system is used wherein the carrier signal is phase shift key modulated. Upon demodulation in demodulator 350 the encoded, analog telephony signal is extracted. The encoded, analog telephony signal is then input to analog to digital converter 351 which digitizes the encoded analog telephony signal. The now digitized and encoded telephony signal is then input to decoder 352 which decodes the signal to obtain the digitized telephony signal which is then sent to Telephone System 114. The type of decoding that is done depends upon the system, and the types include, but are not limited to, the well-known CDMA and GSM systems.

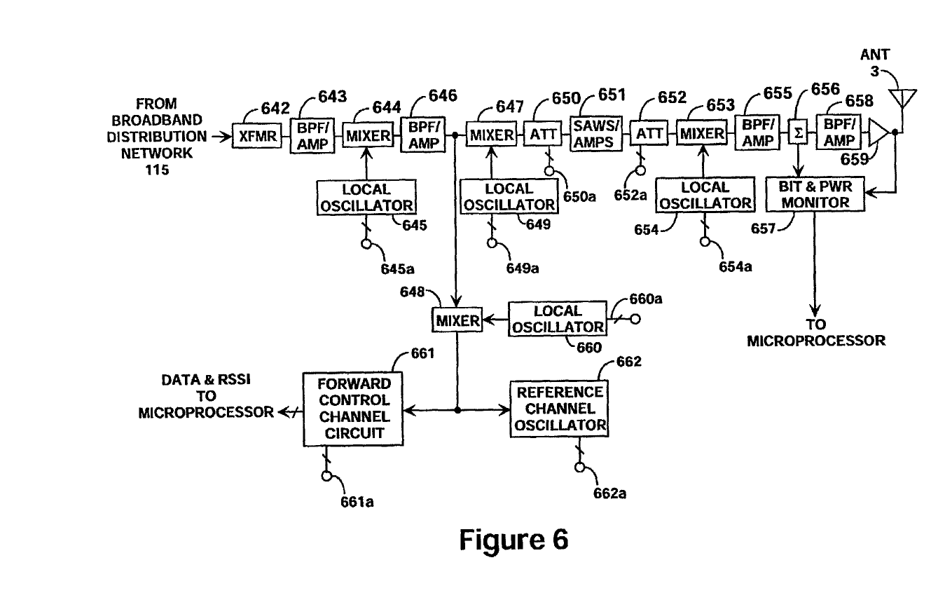

In the forward direction of alpha channel 319a of BTS 311, shown in the bottom row of FIG. 3, digitized telephony signals received from Telephone System 115 are input to encoder 353. The type of encoding that is done depends upon the type of system and includes, but is not limited to, the well-known CDMA and GSM systems. The encoded digital telephony signal is then input to digital to analog converter 354 which converts the telephony signal into an analog signal. The analog, encoded telephony signal is then input to modulator 355 which, in the prior art Base Transceiver Station (BTS) 116 shown in FIG. 6, phase shift key modulates an IF carrier signal in a matter well-known in the art. The IF carrier signal, modulated by the analog, encoded telephony signal, is then input to transceiver 366 which translates the IF carrier signal frequency to an RF carrier signal. The modulated RF carrier signal is then amplified by amplifier 367, spurious signals are filtered out by filter 368 and the RF carrier signal is sent to RASP 218. RASP 218 receives the RF carrier signal and processes it in the manner described in greater detail further in this Detailed Specification.

In FIG. 4 is shown a detailed block diagram of the portion of the Remote Antenna Signal Processor (RASP) 218 in FIG. 2 that processes telephony signals received from the Base Transceiver Station (BTS) 211 and forwards them via Broadband Distribution Network 215 and RAD 117 to a wireless telephone (not shown) in blind area 116.

Within the RASP circuit are three parallel circuits 418a-c. These three circuits are referred to as alpha, beta and gamma channels in the RASP and they operate in the same manner except for their frequency of operation. To simplify the description of the RASP circuit, only one of these three circuits, alpha channel 418a, is shown and described in detail. Common circuitry is also described.

Telephony signals received from BTS 111 on the alpha channel 218a are input to bandpass filter 432 to remove all out of band signals. The filtered telephony signals are then input to mixer 433 along with a signal from oscillator OSC5. The heterodyning process of mixer 433 produces a number of unwanted signals which are removed by bandpass filter 435 which passes only the desired telephony signals at an IF frequency.

The filtered telephony signals in alpha channel 418a are then input to a second mixer 436 along with input from oscillator OSC6. Oscillator OSC6, and other oscillators in the alpha, beta and gamma channels, are each controlled by a microprocessor (not shown) and are set to different frequencies depending on the frequencies that the frequency multiplexed telephony signals in the alpha, beta and gamma channel are to be transmitted over Broadband Distribution Network 115.

All signals output from mixer 436 are input to combiner 438 which also has similar inputs from the mixers (not shown) in the beta and gamma channels. Combiner 438 combines the signals from the alpha, beta and gamma channels 218a-c into a first frequency multiplexed signal which is input to bandpass filter 439 where all unwanted frequencies from the heterodyning process are removed. Only the desired telephony signals on the alpha, beta and gamma channels are passed through filter 439 to mixer 440.

Mixer 440 is used to shift the frequency of the telephony signals to their assigned frequency on broadband distribution network 115. To accomplish this mixing process there is another input to mixer 440 from oscillator OSC7. The frequency of oscillator OSC7 is set by the microprocessor (not shown).

As known in the art the output of mixer 440 includes many unwanted signals which are removed by bandpass filter 443. Bandpass filter 443 only passes the desired frequency multiplexed telephony signals in the alpha, beta and gamma channels.

The frequency multiplexed telephony signals from all three channels are amplified by amplifier 444 before being input to diplexer 445. There is a second input to diplexer 445 that is now described.

On lead f from BTS 111 is a reference signal received from BTS 111. This reference signal is used by all oscillators in RASP 118, and is also transmitted to and used as a reference oscillator signal for all local oscillators in RADs 117.

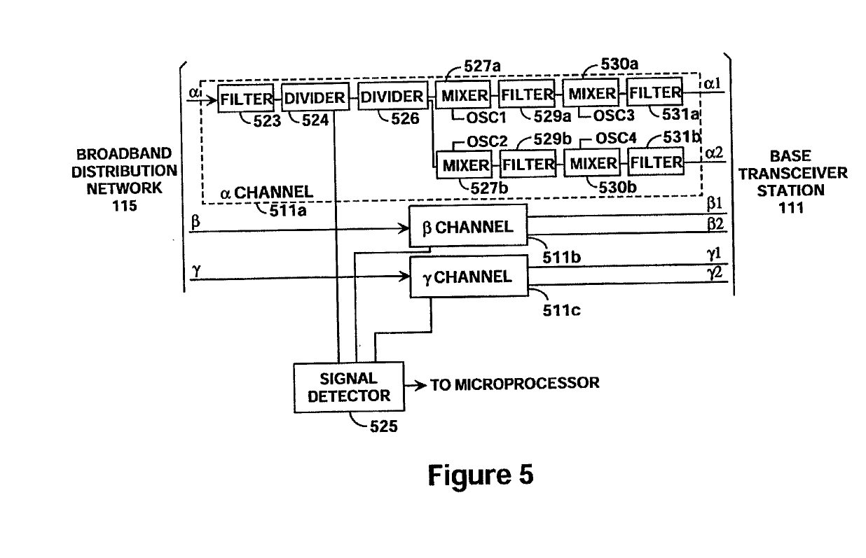

In FIG. 5 is shown a block diagram of the reverse direction portion of a Remote Antenna Signal Processor (RASP) 118. The reverse direction circuitry processes telephony and control signals received from wireless telephones (not shown) and RADs 117, and received via Broadband Distribution Network 115, and forwards them to BTS 111.

Within the RASP circuit are three parallel channel circuits 511a, 511b and 511c. These three circuits are referred to as alpha, beta and gamma channels and they operate in the same manner except for their frequency of operation to handle telephony signals in different channels. To simplify the description of the reverse direction RASP circuit shown in FIG. 5, only alpha channel circuit 511a is described in detail. There may be more than three such channel circuits in a RASP.

Telephony signals from a wireless telephone (not shown), and control signals from a RAD 117 that is carrying the telephony signals, are carried over Broadband Distribution Network 115 to bandpass filter 523 at the input of alpha channel 511a. These telephony and control signals are divided for further processing as described further in this detailed description. Filter 523 removes out of band signals that are present on Broadband Distribution Network 115 before the telephony and control signals are input to signal divider 524. Divider 524 divides and applies the combined telephony and control signals to both divider 526 and signal detector 525.

Signal detector 525 separates the control signals from the telephony signal and forwards the control signals to a microprocessor (not shown) for processing. The microprocessor analyzes the control signals and causes circuit adjustments to be made in RASP 118 and RAD 117.

Divider 524 also applies the telephony signal to divider 526 which again divides the signal, which telephony signal includes the combined signals from the primary receive antenna and diversity receive antenna of a RAD 117, and applies them to mixers 527a and 527b. As briefly described hereinabove, the telephony signal received by the primary receive antenna and diversity receive antenna from a single RAD 117 are frequency multiplexed together. Mixers 527a and 527b are used to separate these two frequency multiplexed telephony signals.

Mixer 527a has a second input from oscillator OSC1, and mixer 527b has a second input from oscillator OSC2. The frequency of oscillators OSC1 and OSC2 are different and the mixing process of mixers 527a and 527b causes the modulated carrier signal output from each of the mixers to have the same intermediate frequency (IF) carrier signal. The frequency of oscillators OSCI and OSC2 are controlled by the microprocessor (not shown) and are set according to the assigned frequency of operation for the alpha channel on Broadband Distribution Network 115.

The heterodyning process of mixers 527a and 527b produce a number of unwanted signals which are removed respectively by bandpass filters 529a and 529b, and which respectively pass only the desired telephony signal from the primary receive antenna and the diversity receive antenna.

Only the primary receive antenna telephony signal is output from filter 529a and is input to mixer 530a where it is mixed with a signal from oscillator OSC3. The heterodyning process of mixer 530a is used to translate the intermediate frequency (IF) carrier signal, modulated with the primary receive antenna telephony signal, to a radio frequency (RF) carrier signal that is transmitted via path alpha 1 to BTS 111. The heterodyning process of mixer 530a also produces a number of unwanted signals that are removed by bandpass filter 531a.

Only the secondary receive antenna telephony signal is output from filter 529b and is input to mixer 530b where it is mixed with a signal from oscillator OSC4. The heterodyning process of mixer 530b is used to translate the IF carrier signal, modulated with the secondary receive antenna telephony signal, to an RF carrier signal that is transmitted via path alpha 2 to BTS 111. The heterodyning process of mixer 530b also produces a number of unwanted signals that are removed by bandpass filter 531b.

In FIG. 6 is shown a detailed block diagram of the downstream or forward circuitry of RAD 117 that carries telephony signals to wireless telephones (not shown). As previously described, RAD 117 hangs from and is connected to Broadband Distribution Network 115. Transformer 642 is an impedance matching transformer having 75 ohm primary and 50 ohm secondary windings. When Broadband Distribution Network 115 is coaxial cable, the primary winding of transformer 642 is wired in series with the center conductor of the coaxial cable. Transformer 642 is used to connect frequency multiplexed telephony and control signals carried on Broadband Distribution Network 115 from RASP 118 to the input of this RAD circuit. Only a RAD 117, the receive frequency of which has been tuned to the particular frequency of telephony and control signals on Broadband Distribution Network 115 can actually receive and forward the telephony signals to a wireless telephone (not shown).

All RADs 117 connected to Broadband Distribution Network 115 receive control signals directed toward any one of the RADs. However, each RAD 117 has a unique address that prefixes each control signal and is used by each RAD 117 to accept only control signals directed specifically to it by RASP 118.

The frequency multiplexed telephony and control signals received by the RAD circuitry in FIG. 6 from Broadband Distribution Network 115 are input to band pass filter and amplifier 643. Filter 643 passes all possible frequency multiplexed telephony and control signals that are carried on Broadband Distribution Network 115, and excludes other unwanted signals carried on Network 115. Circuit 643 also amplifies the signals that pass through filter 642.

The signals output from filter 643 are input to mixer 644 along with a signal from local oscillator 645. Alike other local oscillators shown in FIG. 6, the frequency of local oscillator 645 is digitally controlled at its input 645a by a microprocessor (not shown) responsive to frequency reference signals received from RASP 118, as briefly described hereinabove.

The operation of mixer 644 results in multiple frequencies being output from the mixer as is known in the art and unwanted frequencies are blocked by band pass filter and amplifier 646 which passes only desired signals. The selected set of telephony and control signals are amplified and are input to mixer 647. As mentioned above local oscillator 649 is digitally controlled at its control input 649a by the microprocessor (not shown) responsive to reference signals received from RASP 118. In a manner wellknown in the art, mixer 647 combines the signals input to it and provides a number of output signals at different frequencies. All these frequencies are input to an attenuator 650 which is used to adjust the gain level of the signals. Attenuator 650 is part of the gain control system and is digitally controlled at its input 650a in ½ dB steps by the microprocessor (not shown), responsive to gain control signals received from RASP 118.

The gain adjusted signal output from attenuator 650 is input to SAW filter and amplifier 651. Due to the sharp filtering operation of SAW filter 651, even spurious signals close to the desired telephony and control signals are removed. Control signals frequency multiplexed with the telephony signal do not pass through SAW filter 651. Instead, the control signals are input to mixer 648 as is described further in this specification.

The telephony signals passing through SAW filter 651 are input to digitally controlled attenuator 652 to adjust the gain level of the signal before it is input to mixer 653 along with the output of microprocessor controlled local oscillator 654. Attenuator 652 is part of the gain control system and is digitally controlled at its control input 652a in 2 dB steps by the microprocessor (not shown), responsive to gain control signals received from RASP 118.

The amplitude adjusted telephony signal output from attenuator 652 is input to mixer 653 along with a signal from digitally controlled oscillator 654. Oscillator 654 is also controlled by the microprocessor, responsive to gain control signals received from RASP 118, in the same manner as local oscillators 645, 649 and 660. Mixer 653 combines the two signals in a manner well-known in the art to produce several output signals, one of which is the telephony signal now having the desired RF carrier frequency for transmission of the telephony signal to a remote wireless telephone (not shown). The signals output from mixer 653 are input to band pass filter and amplifier 655. Band pass filter 655 passes only the desired RF carrier frequency. The signal is also amplified before being input to signal divider 656.

A portion of the telephony signal input to divider 656 is divided and input to bit and power monitor 657, while the remainder of the signal is input to band pass filter and amplifier 658. Bandpass filter 658 assures that there are no extraneous signals combined with the desired telephony signal, amplifies same, and applies it to power amplifier 659. Power amplifier 659 amplifies the telephony signal and couples it to transmit antenna 621a. The signal is transmitted within the physical area for signal coverage of RAD 117 and is received by a remote wireless telephone (not shown) which is in this area.

The telephony signal input to bandpass filter 658 is divided by divider 656 and the sample is input to BIT and Power Monitor 657. The level of the telephony signal is reported to the microprocessor (not shown) which reports same to RASP 118 as part of the control signals. In addition, the output of power amplifier 659 is also sampled and input to BIT and Power Monitor 657 which reports the signal level to the microprocessor which in turn reports it to RASP 118. This signal level measurement is used in concert with attenuators 650 and 652, as controlled by RASP 118, to adjust the power level of the telephony signal to be applied to the transmit antenna. If the signal level output from power amplifier 659 is too high, and cannot be adjusted within specification by attenuators 650 and 652, microprocessor will shut down this RAD 117.

A portion of the signal output from bandpass filter and amplifier 646, and still including the control signals, is input to mixer 648 along with a signal from local oscillator 660. The output of mixer 648 is input to reference channel oscillator 662 and forward control channel circuit 661. Circuit 661 accepts only control signals sent from RASP 118 and sends them to the microprocessor. Control signals have a prefixed RAD address as part of the control signals and each RAD 117 has a unique address. Therefore, the microprocessor in each RAD 117 can recognize and accept only control signals directed to it from RASP 118.

When a RAD 117 receives control signals directed to it by RASP 118, the microprocessor responds thereto to perform the action required by RASP 118. The control signal may ask for the settings of the local oscillators and attenuators, and this information is returned to RASP 118 using a control signal oscillator as described herein. The control signal from RASP 118 may also indicate revised settings for local oscillators and attenuators. The microprocessor makes the required changes to the circuits and then sends a confirmation signal back to RASP 118 indicating that the requested changes have been made. As part of the gain control operation the control signal from RASP 118 may also request information concerning the outputs from bit and power monitor 657. Responsive to any of these control signals the microprocessor performs the requests.

Reference channel oscillator 662 processes the output of mixer 648 to obtain the reference oscillator signal sent from RASP 118, and generates a phase lock loop reference signal that is used to provide a master frequency to all local oscillators within RAD 117 to match their frequency of operation with RASP 118.

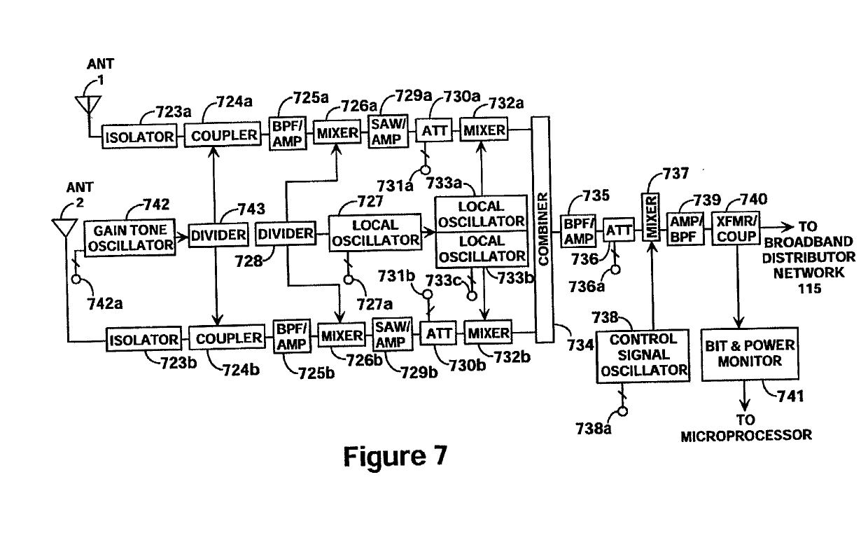

In FIG. 7 is shown a detailed block diagram of the upstream or reverse circuitry within Remote Antenna Driver (RAD) 117 that carries telephony signals from a wireless telephone (not shown), and via Broadband Distribution Network 115, to RASP 118.

Briefly, primary receive antenna 721b is connected to a first portion of the circuitry in FIG. 7, and that circuitry is identical to a second portion of the circuitry that is connected to diversity receive antenna 721c. The telephony signals received by both antennas 721b and 721c from a wireless telephone (not shown) are initially processed in parallel, then the two received signals are both frequency multiplexed together and both are returned via Broadband Distribution Network 115 to remote RASP 118 to be processed.

Telephony signals from a wireless telephone (not shown in FIG. 7) operating in the blind area 116 assigned to RAD 117b are received by primary receive antenna 721b. The signals are input to an isolator 723a which isolates antenna 721b from the downstream RAD circuit shown in FIG. 6. The received telephony signal is then input to directional coupler 724a that has a second signal input thereto from power divider 743 and gain tone oscillator 742 which are used for gain control measurement purposes.

The telephony signal (modulated RF carrier) received from a remote wireless telephone, and the gain tone, are applied via directional coupler 724a to a combined band pass filter and amplifier 725a. The signals are amplified and extraneous signals are filtered from the received telephony signal by bandpass filter 725a. The operation just described also applies to isolator 723b, coupler 724b and bandpass filter and amplifier 725b.

The amplified and filtered telephony signal is then input to mixer 726a which is used along with SAW filter 729a to assist in filtering of the spread spectrum, digital telephony signal. Mixer 726a also has input thereto a signal from local oscillator 727. This signal from local oscillator 727 is input to divider 728 which applies the signal to both mixers 726a and 726b while providing isolation between these two mixers.

The frequency of local oscillator 727 is digitally controlled and is determined by a binary control word applied to its control input 727a from a microprocessor (not shown), responsive to control signals received from RASP 118. Similarly, control signals from remote RASP 118 causes the microprocessor to set the frequency of digitally controlled local oscillators 733a and 733b.

The operation of mixer 726a results in multiple frequencies being output from the mixer as is known in the art, but due to the frequency of oscillator 727, most of the signals present at the input of RAD circuit 723a from antenna 721b are shifted far outside the band of frequencies which can pass through SAW filter 729a. Only the desired signals can pass through SAW filter 729a. This frequency shift also helps to prevent leak through of unwanted signals present at the input of circuit 723a because they are blocked by narrow bandpass filter 725a which is passing signals of a frequency far from the signals applied to SAW filter 729a. Due to the sharp filtering action of SAW filter 729a, even spurious signals close to the desired telephony and control tone signals are removed. The same filtering operation applies to mixer 726b and SAW filter 729b.

The filtered telephony signal is then amplified by amplifier 729a and input to step attenuator 730a which is used to adjust the gain level of the signal in one-half dB steps. The amount of attenuation provided by step attenuator 730a is controlled by a binary word at its control input 731a from the microprocessor (not shown). The control of step attenuators 730a, 730b, and 736 is accomplished responsive to control signals from RASP 118 as part of a gain control operation that assures that the signal level of telephony signals appearing at the input of RASP 118 from RAD 117 is within an acceptable range. Attenuator 730b in the parallel channel handling the telephony signals from diversity receive antenna 721c performs the same function.

The telephony signal that is output from step attenuator 730a is input to mixer 732a along with a fixed frequency signal from local oscillator 733a. Mixer 732a is used to shift the frequency of the telephony and gain tone signals to the frequency required to apply the signals to Broadband Distribution Network 115. This same operation applies to the telephony and gain tone signals output from mixer 732b.

The frequency of oscillators 733a and 733b is determined by binary words applied to their control input 733c. A control signal is sent from RASP 118 which causes the microprocessor to set the frequency of local oscillators 733a and 733b. The frequency of the telephony signal output from step attenuator 730a is the same as the frequency of the telephony signal output from step attenuator 730b. However, the frequency of local oscillator 733a is different from the frequency of local oscillator 733b. The result is that the RF carrier frequency of the telephony and gain tone signals output from mixer 732a is different than the RF carrier frequency of the telephony and gain tone signals output from mixer 732b. This is done so that both primary receive antenna 721b and diversity receive antenna 721c signals are both sent to RASP 118 and BTS 111 in frequency multiplexed form for processing. However, all carrier frequencies are within the frequency band of the assigned wireless telephony channel on Broadband Distribution Newtwork 115.

The telephony signals received by primary receive antenna 721b and diversity receive antenna 721c are frequency multiplexed together and sent via Broadband Distribution Network 115 to RASP 118.To accomplish this, combiner 734 is utilized. Combiner 734 has the telephony and gain tone signals output from both mixers 732a and 732b input thereto. As described in the previous paragraph these two received telephony signals modulate carriers that are at different frequencies, but both frequencies are in an assigned channel of Broadband Distribution Network 115. Combiner 734 combines the two sets of signals so they are frequency multiplexed together.

The combined signal is input to bandpass filter and amplifier 735 which removes spurious frequencies created by the mixing action in circuits 732a and 732b, and amplifies the signals that pass through the filter. The combined and filtered telephony and gain tone signals are input to step attenuator 736 to adjust the gain level of the signals. Similar to the operation of the previously described step attenuators, this digitally controlled attenuator is set responsive to gain control signals received from remote RASP 118 as part pf the gain control operation.

The frequency multiplexed telephony and gain tone signals output from step attenuator 736 are input to mixer 737 which has a second input from control signal oscillator 738. The frequency of control signal oscillator 738 is set responsive to a binary signal on its control leads 738a from the microprocessor. RASP 118 is the origin of the cotrol signal used to set the frequency of control signal oscillator 738.

Responsive to different control signals received from RASP 118, the microprocessor (not shown) applies signals to control input 738a. These microprocessor signals cause control signal oscillator 738 to produce an information signal. The information signal indicates various information about RAD 117, but particularly including the settings of step attenuators 730a, 730b and 736, to RASP 118 as part of the gain control operation. RASP 118 uses this information to keep an updated status regarding RAD 117.

The output from mixer 737 now has five signals frequency multiplexed together to be returned via Broadband Distribution Network 115 to RASP 118. The signals are the telephony signal received by primary receive antenna 721b, the telephony signal received by diversity receive antenna 721c, the gain tone signal output from gain tone oscillator 742 as applied to both primary receive and diversity receive paths, and the system information signal output from control signal oscillator 738. This frequency multiplexed signal output from combiner 737 is input to band pass filter and amplifier 739 to remove any extraneous signals and amplify the desired signals before they are input to Broadband Distribution Network 115 and sent to RASP 118.

Transformer and coupler 740 is used to couple the frequency multiplexed signals described in the previous paragraphs to Broadband Distribution Network 115. The transformer 740 is an impedance matching transfomer having 50 ohm primary and 75 ohm secondary windings. When Broadband Distribution Network 115 uses coaxial cable, the secondary winding of transformer 740 is wired in series with the center conductor of the coaxial The invention in accordance with claim I wherein cable. As previously described, RAD 117 hangs from the coaxial cabling of the Broadband Distribution Network 115 to which it is connected. In other applications, such as with fiber optic cable, other well known frequency conversion and signal coupling techniques are used.

A small portion of the frequency multiplexed signals passing through transformer and coupler 740 is coupled to Built In Test (BIT) and power monitor 741. Monitor 741 samples the signal level of the combined signals that are being input to Broadband Distribution Network 115 and reports this information to RASP 118 via control signal oscillator 738 which has been previously described. If the output signal level is too high and the level cannot be corrected, the microprocessor will shut down RAD 117 and report this to RASP 118.

While what has been described hereinabove is the preferred embodiment of the present invention, it may be appreciated that one skilled in the art may make numerous changes without departing from the spirit and scope of the present invention.

What is claimed is:

1. A method for providing coverage for access to a wireless communication system comprising the steps of:
locating wireless communication equipment in a first group of cells, the first group of cells located in a first defined area; and
simulcasting radio signals on a common radio frequency (RF) carrier in the first group of cells, such that handoff does not occur while a mobile unit travels along at least a portion of the defined area between the cells therein.

2. A method as in claim 1 wherein the defined area is a corridor along which vehicles travel.

3. A method as in claim 2 additionally comprising the step of:
locating wireless communication base station tranceiver equipment at a cell located at a junction between at least two corridors along which vehicles travel.

4. A method as in claim 3 wherein different RF carriers are assigned to the first group of cells and to the cell at the corridor junction location so that handoff from one RF carrier to another R carrier occurs only at the corridor junction location.

5. A method as in claim 3 wherein the corridors are subway tunnels.

6. A method as in claim 5 wherein the junction is a subway station.

7. A method as in claim 3 wherein the corridors are railway tracks.

8. A method as in claim 7 wherein the junction is a railway station.

9. A method as in claim 3 wherein the junction is at an area of expected slow speed mobility.

10. A method as in claim 1 wherein the defined area is an area of expected high speed mobility.

11. A method as in claim 1 wherein the wireless communication equipment located in the first group of cells further comprises Remote Antenna Driver (RAD) equipment.

12. A method as in claim 3 wherein the vehicles travel along the corridor according to an expected schedule, and radio channel allocation is made to the first group of cells according to the schedule.

13. A method as in claim 12 wherein the schedule indicates an expected time of travel of a vehicle through the defined area, and the radio channel allocation is made for such times.

14. A method as in claim 12 wherein the schedule indicates an expected time of travel of a vehicle through the junction without stopping, and the radio channel allocation is maintained for mobile units crossing from one of the first group of cells into a cell located at the corridor junction location.

15. A method as in claim 1 wherein the step of simulcasting additionally comprises the step of simulcasting a first set of radio carrier frequencies.

16. A method for providing wireless communication service in an area in which a base transceiver station with a tower mounted antenna carries telephony signals between wireless communication devices operating in said area and a network communication system, said method comprising:
transmitting a communication signal from said base transceiver station to a plurality of remote transmitters physically located in another contiguous area at the same time that said communication signal is transmitted to a wireless communication device that is operating in part of said area using said tower mounted antenna;and
re-transmitting said communication signal to said wireless communication device using said remote transmitters as said wireless communication device travels through respective portions of said area covered by said remote transmitters.
